(19) United States
(12) Patent Application Publication
(10) Pub. No.: US 2005/0030684 A1
(43) Pub. Date: Feb. 10, 2005

(54) Low-voltage electronic residual current circuit breaker

(76) Inventor: Salvatore Brandonisio, Milano (IT)

Correspondence Address: CONNOLLY BOVE LODGE & HUTZ LLP, SUITE 800, 1990 M STREET NW, WASHINGTON, DC, 20036-3425, US

(21) Appl. No.: 10/451,541

(22) PCT Filed: Dec. 11, 2001
(86) PCT No.: PCT/EP01/14696

(30) Foreign Application Priority Data
Dec. 28, 2000 (IT) M100A0028949

(51) Int. Cl. H02H 3/00

(52) U.S. Cl. 361/42

(57) ABSTRACT

A low-voltage electronic residual current circuit breaker, comprising, a) at least one fixed contact and at least one movable contact, the movable contact coupling/uncoupling with respect to the fixed contact respectively during closure/opening of the circuit breaker; b) sensor means which are suitable to generate one or more electrical sensing signals that are indicative of the presence of an earth fault current; c) first electrinally connected to the sensor means, in order to generate, upon receiving the sensing signals, one or more electrical control signals, the first electronic means being electrically conected to release means that are operatively connected to the movable contact in order to uncouple it from the fixed contact, following reception of the one or more electrical control signals; and d) an electronic testing device that is electrically connected to the first sensor means and is suitable to simulate the presence of an earth fault current; whose particularity consists of the fact that said electronic testing device comprises, a′) at least one first active electronic circuit, which is electrically connected to the sensor means and generates an electrical test signal for activating the sensor means; and b′) at least one second active electronic circuit, with is suitable to drive the first active electronic circuit.

The present invention relates to an electronic residual current circuit breaker with improved functions.

In particular, the present invention relates to an electronic residual current circuit breaker that is particularly suitable for use in single-phase or multiple-phase applications, e. g. two-phase, three-phase, et cetera, at low voltage, i.e. with operating voltage values up to 1000 V.

Many examples of low-voltage residual current circuit breakers are known in the art.

An electronic residual current circuit breaker generally comprises a current transducer suitable to detect the presence of an earth fault current. The current transducer is generally constituted by a magnetic toroidal core, which is provided with a primary winding, which includes one or more phase conductors of an electrical line, enclosed by the toroidal core, and by a secondary winding, which includes one or more turns wound around the toroidal core. The secondary winding is electrically connected to an electronic control circuit. In the presence of a fault current, the electronic control circuit activates an electromagnetic release that is operatively connected to the electrical contacts of the circuit breaker. The electromagnetic release causes the separation of the electrical contacts of the circuit breaker and therefore the interruption of the electrical line with which the circuit breaker is associated. The electronic control circuit and the electromagnetic release require a power supply voltage, which is provided by a power supply device that is usually connected to the phase conductors of the electrical line.

It is known that electronic residual current circuit breakers according to the current art also comprise an electronic testing device that allows to test the tripping efficiency of the circuit breaker. The electronic testing device, whose presence is prescribed by the statutory provisions currently in force, can, by activation on the part of the user, simulate the presence of a fault current and therefore cause the interruption of the power line.

According to a first conventional approach, the electronic testing device comprises a test button, which can be activated by the user and is electrically connected to an electronic circuit of the resistive type, which is in turn connected electrically to two terminals of the power supply device of the circuit breaker. The resistive electronic circuit is provided so as to have at least one circuit branch enclosed by the toroidal core of the current transducer. The activation of the test button causes the circulation of a test current through said circuit branch. The test current is detected by the current transducer as if it were an ordinary fault current. Accordingly, the electronic control circuit trips immediately and causes, by virtue of the electromagnetic release, the interruption of the electrical line.

In accordance with a second conventional known type of approach, the resistive circuit comprised with the electronic testing device is not connected- to two terminals of the power supply device but is connected to a phase conductor and to a single terminal of the power supply device, in particular downstream of the electronic rectifier circuits.

The electronic residual current circuit breakers according to the current art have drawbacks.

The electronic testing devices provided according to the first described conventional approach constitute in practice a constraint for the power supply wiring of the residual current circuit breaker, which must provide for the presence of two predefined power supply terminals. This is a considerable drawback during the manufacture and installation of the electronic residual current circuit breaker. This disadvantage is solved only partially in the second described conventional approach, since also in this case there is still a constraint to the power supply wiring of the switch, constituted by the presence of a predefined power supply terminal.

Another drawback arises from the fact that in testing devices provided according to conventional techniques, the intensity of the testing current depends essentially on the power supply voltage of the circuit breaker. Very often, therefore, one has to resort to limiting said testing current by using nonlinear electronic components, for example appropriately connected Zener diodes. Furthermore, if there is a relatively large power supply range, it is necessary to provide a considerable thermal oversizing of the electronic components that are used. This is of course a considerable disadvantage in terms of production costs of the circuit breaker. Moreover, high heat dissipations can entail considerable reliability and durability problems.

The aim of the present invention is to provide an electronic residual current circuit breaker for low-voltage applications that is provided with an electronic testing device that allows to overcome the described drawbacks.

Within the scope of this aim, an object of the present invention is to provide an electronic residual current circuit breaker that is provided with an electronic testing device whose operation is substantially independent of the characteristics of the power supply voltage of the electronic residual current circuit breaker.

Another object of the present invention is to provide an electronic residual current circuit breaker that is provided with an electronic testing device that poses no constraints of any kind to the power supply wiring of the electronic residual current circuit breaker.

Another object of the present invention is to provide an electronic residual current circuit breaker that is provided with an electronic testing device that allows to combine efficiency, operating flexibility, reduced size and competitive costs.

This aim and these and other objects that will become better apparent hereinafter are achieved by a low-voltage electronic residual current circuit breaker, comprising at least one fixed contact and at least one movable contact. The movable contact can be coupled/uncoupled with respect to the fixed contact respectively during closure/opening of the residual current circuit breaker. The electronic residual current circuit breaker according to the present invention comprises sensor means, which are suitable to generate one or more electrical sensing signals that are indicative of the presence of an earth fault current, and first electronic means, which are electrically connected to said sensor means and are suitable to generate, upon receiving said sensing signals, one or more electrical control signals. Said electronic means are electrically connected to release means that are operatively connected to said movable contact in order to uncouple it from said fixed contact following reception of said one or more electrical control signals. The electronic residual current circuit breaker according to the present invention furthermore comprises an electronic testing device that is electrically connected to said first sensor means, said electronic testing device being suitable to simulate the presence of an earth fault current, and is characterized in that said electronic testing device comprises:
a first active electronic circuit which is electrically connected to said sensor means and generates an electrical test signal for activating said sensor means; and a second active electronic circuit, which is suitable to drive said first active electronic circuit.

Further characteristics and advantages will become better apparent in the following description, which describes some embodiments of the electronic residual current circuit breaker according to the present invention with particular reference to the following figures, wherein:

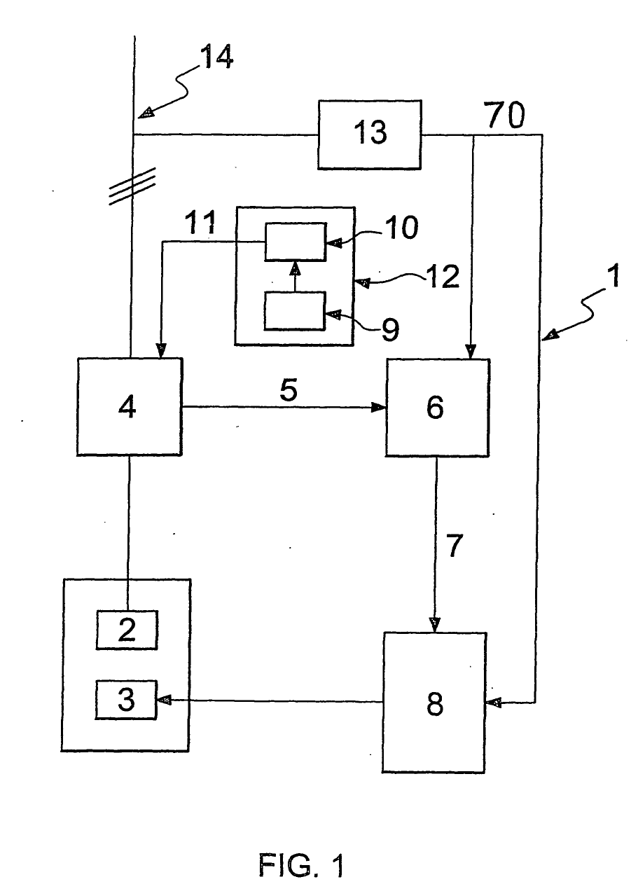

FIG. 1 is a schematic view representing the structure of the electronic residual current circuit breaker according to the present invention;

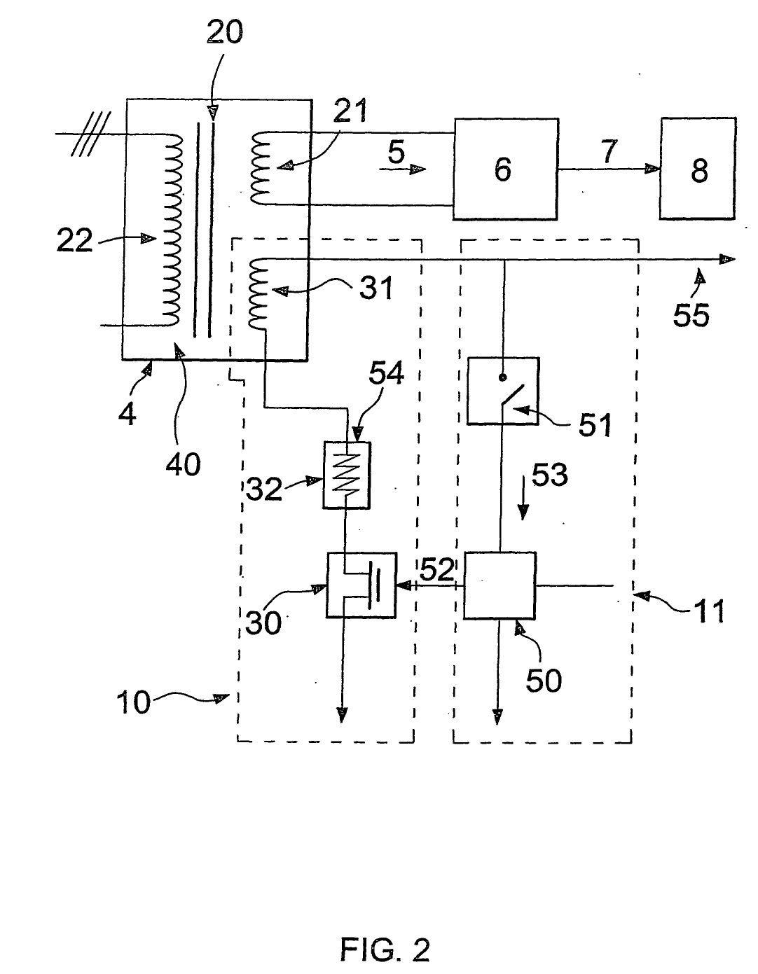

FIG. 2 is a schematic view representing a detail of a first preferred embodiment of the electronic residual current circuit breaker according to the present invention; and

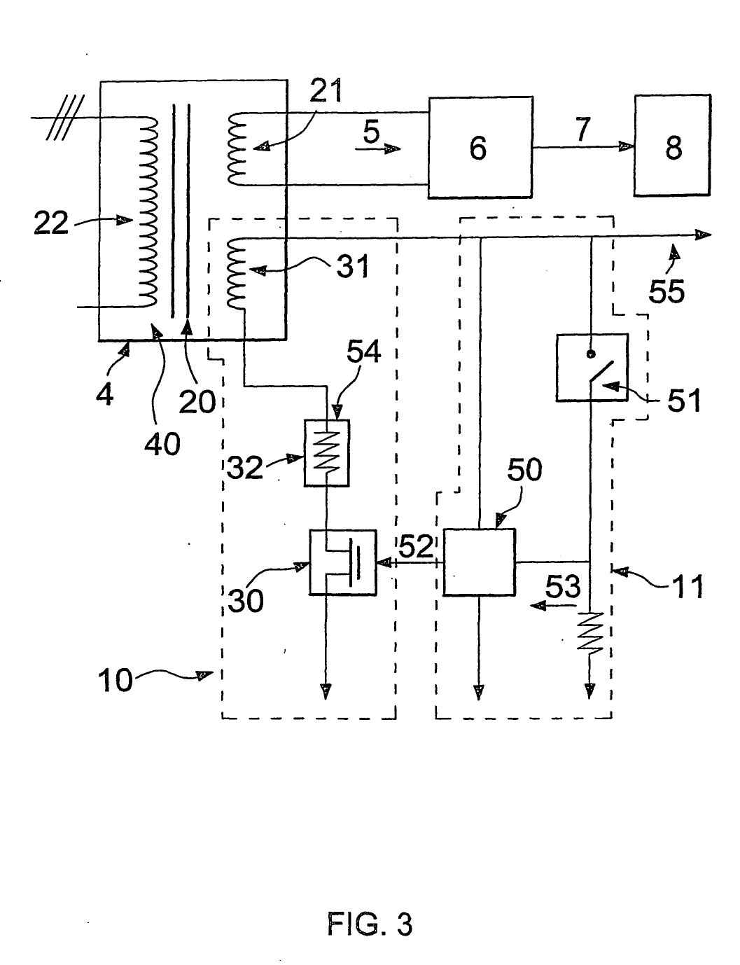

FIG. 3 is a schematic view representing a detail of a second preferred embodiment of the electronic residual current circuit breaker according to the present invention.

With reference to FIG. 1, the low-voltage electronic residual current circuit breaker according to the present invention, generally designated by the reference numeral 1, comprises at least one fixed contact 2 and one movable contact 3. The movable contact 3 can be coupled/uncoupled with respect to the fixed contact 2, respectively during the closure/opening of the circuit breaker 1. The circuit breaker 1 further comprises sensor means 4 which are suitable to generate one or more electrical sensing signals 5 that are indicative of the presence of an earth fault current. Furthermore, the circuit breaker 1 comprises first electronic means 6 which are electrically connected to the sensor means 4 and are suitable to generate, following reception of said sensing signals 5, one or more electrical control signals 7. The first electronic means 6 are electrically connected to release means 8, which are operatively connected to the movable contact 3. Upon receiving the electrical control signals 7, the release means 8 uncouple the movable contact 3 from the fixed contact 2. The residual current circuit breaker 1 also comprises an electronic testing device 9 that is electrically connected to the first sensor means 4. The electronic testing device 9 is suitable to simulate the presence of an earth fault current. It comprises a first active electronic circuit 10 that is electrically connected to the sensor means 4. The first active electronic circuit 10 generates an electrical test signal 11 that is suitable to activate the sensor means 4. The electronic testing device 9 also comprises a second active electronic circuit 12 that is suitable to drive the first active electronic circuit 10.

Advantageously, the test signal 11 is an alternate current (AC) electrical signal whose waveform is adjustable by means of the first active electronic circuit 10. Also with reference to FIGS. 2 and 3, the sensor means 4 comprise a current transducer 40, which preferably includes a magnetic core 20 and at least one first secondary winding 21 that is electrically connected to the first electronic means 6. The current transducer 40 advantageously also comprises a primary winding 22 that comprises one or more electrical phase conductors, indicated by the numeral reference 14 of FIG. 1, enclosed by the magnetic core 20. The electronic residual current circuit breaker 1 can also comprise a power supply device 13 that is electrically connected to one or more electrical phase conductors 14. The power supply device 13 supplies a power supply voltage 70 to the first electronic means 6 and/or to the release means 8.

Preferably, as illustrated in FIGS. 2 and 3, the first active electronic circuit 10 comprises at least one first active element 30 and one second secondary winding 31 of the current transducer 40. The second secondary winding 31 is preferably series-connected to the first active element 30. Furthermore, the first active electronic circuit 10 advantageously comprises a current regulator device 32. The current regulator device 32 can comprise, for example a resistive circuit, as shown in FIGS. 2 and 3, or according to alternative solutions whose concept is within the knowledge of the person skilled in the art.

The first active element 30 advantageously comprises an electronic switch, such as for example a transistor of the BJT, MOSFET, JFET type or the like, conveniently configured so as to allow/prevent the circulation of current in the second secondary winding 31.

Preferably, the second active electronic circuit comprises at least one second active element 50 and a test button 51 that is electrically connected to the second active element 50.

The test button 51 can be activated by the user, generating a control signal 53 for the second active element 50.

Advantageously, the second active element 50 can comprise, for example in the embodiment of FIG. 2, an oscillator which can be preferably kept in a standby situation until activation by the control signal 53. Alternatively, the second active element 50 can comprise, for example in the embodiment of FIG. 3, a microprocessor which can be kept always active. In this case, the microprocessor considers the control signal 53 as an input capable of activating a predefined processing program.

In any case, after receiving in input the control signal 53, the second active element 50 generates in output a driving signal 52 which is suitable to regulate the operation of the first active element 30. The driving signal 52, preferably of the pulsed type, alternatively switches off and on the first active element 30. Preferably, the first active electronic circuit 10 and/or the second active electronic circuit 12 are powered by a regulated supply voltage 55. In this manner, an AC test current 54 circulates in the first active electronic circuit 10 and therefore also in the second secondary winding 31. The test current 54 is sensed by the current transducer 40, which sends to the first electronic means 6 sensing signals 5 that indicate the presence of a fault current. In this manner, the release means 8 trip and therefore the electrical line 14 is interrupted. The intensity of the test current 54 is advantageously determined by the power supply voltage 55 and by the current regulator device 32. The frequency and waveform of the test current 54 is determined by the first active element 30. For example, the waveform of the test current 54 can be of the square-wave or sinusoidal type. In any case, the waveform of the test current 54 can be regulated according to the requirements, for example according to the electrical parameters of the current transducer 40.

The power supply voltage 55 is predefined and can be derived in practice from a DC voltage or a sinusoidal voltage, either single- or three-phase, rectified by means of a diode bridge with or without a neutral. In particular, the power supply voltage 55 can be supplied directly by the power supply device 13. In any case, the power supply voltage 55 is substantially independent of the value of the supply voltage provided by the power supply device 13.

The electronic residual current circuit breaker 1 according to the present invention allows to fully achieve the intended aim and objects.

Thanks to the presence of the first active electronic circuit 10 and of the second active electronic circuit 12, the electronic testing device 9 in fact operates substantially independently of the characteristics of the power supply voltage of the electronic residual current circuit breaker 1. In this manner, the electronic testing device 9 does not set substantial installation constraints to the wiring of the electronic residual current circuit breaker 1. Since the waveform of the test current 54 can be regulated, according to the requirements, by the first active electronic circuit 10, the electronic testing device 9 has high efficiency and flexibility in operation. The regulation of the waveform on the part of the first active electronic circuit 10 furthermore allows to significantly reduce heat loss phenomena. The use of a regulated power supply voltage 55 allows to reduce considerably the overall power absorbed by the electronic testing device 9. Furthermore, at least one portion of the first active electronic circuit 10 and of the second active electronic circuit 12 can be easily integrated in a single electronic board or in a single silicon circuit medium. This allows to reduce considerably the overall costs and dimensions of the electronic testing device 9. The electronic residual current circuit breaker according to the present invention thus conceived is susceptible of numerous modifications and variations, all of which are within the scope of the inventive concept.

All the details may further be replaced with other technically equivalent elements.

1. A low-voltage electronic residual current circuit breaker, comprising:
at least one fixed contact and at least one movable contact, said movable contact coupling/uncoupling with respect to said fixed contact respectively during closure/opening of the circuit breaker;
sensor means, which are suitable to generate one or more electrical sensing signals that are indicative of the presence of an earth fault current;
first electronic means electrically connected to said sensor means, in order to generate, upon receiving said sensing signals, one or more electrical control signals, said first electronic means being electrically connected to release means that are operatively connected to said movable contact in order to uncouple it from said fixed contact, following reception of said one or more electrical control signals; and
an electronic testing device that is electrically connected to said first sensor means and is suitable to simulate the presence of an earth fault current; characterized in that said electronic testing device comprises:
at least one first active electronic circuit which is electrically connected to said sensor means and generates an electrical test signal for activating said sensor means; and
at least one second active electronic circuit, which is suitable to drive said first active electronic circuit.

2. The electronic residual current circuit breaker according to claim 1, characterized in that said test signal is an alternate current electrical signal.

3. The electronic residual current circuit breaker according to claim 2, characterized in that said alternate current electrical signal has a waveform that can be regulated by means of said first active electronic circuit.

4. The electronic residual current circuit breaker according to one or more of the preceding claims, characterized in that said sensor means comprise a current transducer that comprises a magnetic core, at least one first secondary winding that is electrically connected to said first electronic means, and a primary winding that comprises one or more electrical phase conductors enclosed by said magnetic core.

5. The electronic residual current circuit breaker according to one or more of the preceding claims, characterized in that it comprises a power supply device that is electrically connected to one or more electrical phase conductors, said power supply device being suitable to supply power to said first electronic means and/or to said release means.

6. The electronic residual current circuit breaker according to one or more of the preceding claims, characterized in that said first active electronic circuit comprises at least one first active element and a second secondary winding of said current transducer.

7. The electronic residual current circuit breaker according to claim 6, characterized in that said first active electronic circuit also comprises a current regulator device.

8. The electronic residual current circuit breaker according to one or more of the preceding claims, characterized in that said second active electronic circuit comprises at least one second active element and a test button that is electrically connected to said second active element and can be activated by a user.

9. The electronic residual current circuit breaker according to one or more of the preceding claims, characterized in that said first active electronic circuit and/or said second active electronic circuit are supplied by a regulated power supply voltage.

10. The electronic residual current circuit breaker according to claims 5 and 9, characterized in that said first active electronic circuit and/or said second active electronic circuit are supplied by said power supply device.
